(19) United States
(12) Patent Application Publication
(10) Pub. No.: US 2014/0173563 A1
(43) Pub. Date: Jun. 19, 2014

(54) EDITOR VISUALIZATIONS

(71) Applicant: MICROSOFT CORPORATION, Redmond, WA (US)

(72) Inventors: Christopher Dias, Redmond, WA (US); Stephen H. Toub, Seattle, WA (US); Karen Ng, Bellevue, WA (US)

(73) Assignee: MICROSOFT CORPORATION, Redmond, WA (US)

(21) Appl. No.: 13/720,581

(22) Filed: Dec. 19, 2012

(51) Int. Cl. G06F 9/44

(52) U.S. Cl. CPC G06F 8/70
USPC 717/123

(57) ABSTRACT

Methods, systems, and computer program products are provided for inferring the programming intent of code developers to suggest code solutions. Program code is retrieved from a code repository that includes program code generated by a plurality of code developers. The program code is analyzed to determine one or more program code design patterns. A knowledge set is generated that includes the determined program code design pattern(s), and that is network-accessible by software development applications to provide program code suggestions for developing software programs.

### BACKGROUND

Software development environments exist that aid software developers in writing program code. A software development environment may include a source code editor for entering source code, one or more build automation tools, and a code debugger. Examples of commercially available software development environments include Microsoft® Visual Studio®, developed by Microsoft Corporation of Redmond, Wash., JDeveloper® supplied by Oracle Corporation of Redwood City, Calif., ActiveState® Komodo® provided by ActiveState Software Inc. of Vancouver, British Columbia, and Eclipse IDE provided by Eclipse Foundation.

Conventional software development environments provide assistance to developers writing code by presenting lists of possible code “completions” and documentation for those completions, based on a current cursor position within a source code file. The presentation of automatically determined code completions is called “autocompletion.” In Microsoft® Visual Studio®, autocompletion is implemented by functionality referred to as IntelliSense®. According to autocompletion, such as is performed by IntelliSense®, marker characters typed in by a programmer are looked for, such as periods, or other separator characters (depending on the programming language). After the programmer types in one of these marker characters immediately after the name of a term having one or more further selectable code completions, a pre-determined, pop-up list of suggested code completions is presented.

Varying degrees of accuracy are achieved by autocompletion tools such as IntelliSense®, based on the level of sophistication of the programming language being used and the language service providing the data to the software development environment. Code completion suggestions are much more accurate for strongly typed languages such as Visual Basic and C#. Increased scope, such as a solution with both client and server sources, also increases IntelliSense® accuracy. Dynamic languages such as JavaScript typically provide a less accurate suggestion list that contains code completion possibilities (as opposed to specifics) that are potentially nonsensical in the runtime context.

Despite the challenges, IntelliSense® has been one of the most important advancements in developer productivity over the past 15 years. Scoped, valid code completion suggestions improve program quality before the program is ever executed, and, at a minimum, typing productivity is increased.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for inferring the programming intent of code developers to suggest code solutions. Source code generated by one or a body of code developers is collected into a source code base. The source code base is analyzed to determine code design patterns. The code design patterns may be used to suggest code solutions to code developers who are developing software programs. The code solutions may be automatically displayed to the code developers, and a code developer may select one of the code solutions to insert into their software program.

According to one method implementation, program code is retrieved from a code repository. The code repository includes program code generated by a plurality of code developers associated with at least one entity (e.g., a business, a university, etc.). The retrieved program code is analyzed to determine at least one program code design pattern. Each determined program code design pattern includes a pattern signature and a code solution, in some cases an API (application programming interface) library that can be utilized. A knowledge set is generated that includes the determined program code design pattern(s). The knowledge set is network-accessible by software development applications to provide program code suggestions in developing software programs.

Furthermore, a request for a program code suggestion may be received from locally or over a network from a software development application at a user device. The request includes a portion of program code included in a software program input by a code developer to the software development application. The program code portion is compared to program code design patterns included in the knowledge set to select a program code design pattern. The code solution of the selected program code design pattern is transmitted to the software development application at the user device.

According to one system implementation, a software development application in a user device includes a code monitor and a code suggestion interface. The code monitor is configured to transmit a request for a program code suggestion locally or over a network to a program code suggestion system. The request includes a portion of program code included in a software program input by a code developer to the software development application. The code suggestion interface is configured to receive at least one code solution in response to the request. The code solution is selected at the program code suggestion system by comparing the program code portion to a plurality of program code design patterns to infer a programming intent of the code developer. The code suggestion interface is configured to enable display of an indication of the code solution in association with the program code portion.

In another system implementation, a program code suggestion system includes a code analyzer and a knowledge set repository. The code analyzer is configured to receive program code generated by a plurality of code developers associated with at least one entity, and to analyze the received program code to determine at least one program code design pattern. The determined program code design pattern(s) is/are stored in the knowledge set repository. The knowledge set repository is network-accessible by software development applications to provide program code suggestions in developing software programs.

In still another system implementation, a program code suggestion system may include a request handler and a code comparator. The request handler is configured to receive a request over a network for a program code suggestion from a software development application at a user device. The request includes a portion of program code included in a software program input by a code developer to the software development application. The code comparator compares the program code portion to a plurality of program code design patterns included in a knowledge set to select a program code design pattern. The request handler transmits a code solution of the selected program code design pattern to the software development application at the user device.

Computer program products containing computer readable storage media are also described herein that analyze pools of program code generated by developers to determine program code design patterns, that generate a knowledge set that includes the determined program code design patterns, and that may be accessed by software development applications to provide program code solutions in developing software programs, as well as enabling additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a software development system that provides program code solutions generated based on an analysis of a source code base, according to an example embodiment.

FIG. 2 shows a flowchart providing a process for a software development application that requests and receives a program code solution generated based on an analysis of a source code base, according to an example embodiment.

FIG. 3 shows a block diagram of a software development application that provides program code solutions generated based on an analysis of a source code base, according to an example embodiment.

FIGS. 4 and 5 show block diagrams of a user interface that displays program code entered by a developer that is analyzed for code solutions, according to an example embodiment.

FIG. 6 shows a block diagram of a user interface that displays selectable code solutions for program code entered by a developer, according to an example embodiment.

FIG. 7 shows a block diagram of a user interface that displays a graphical indication that one or more code solutions are available for program code entered by a developer, according to an example embodiment.

FIG. 8 shows a block diagram of a user interface that displays a selected code solution inserted into program code, according to an example embodiment.

FIG. 9 shows a flowchart providing a process for crowd source generating a repository of program code design patterns, according to an example embodiment.

FIG. 10 shows a block diagram of a program code suggestion system that generates crowd sourced program code solution, and provides the generated suggestions to software development applications, according to an example embodiment.

FIG. 11 shows a flowchart providing a process for providing crowd sourced program code solutions to software development applications in response to requests, according to an example embodiment.

FIG. 12 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Conventional software development environments use autocompletion to assist developers in writing program code. According to autocompletion, one or more programming terms and/or characters are looked for in the text that is being entered by a computer programmer (also known as a “developer” or “code developer”) into a computer program. If entered terms/characters match a predetermined marker in a list of markers, a pop-up list of suggested code completions for the marker is presented. The programmer may select a suggested code completion from the list to be inserted into the code of the computer program.

For example, a programmer may type in the following code:

1 module Module1
2 Sub Main( )
3 Console.Writeline(“...”)
4 Console.

When the programmer types the last line (line 4), “Console.”, the programmer may be automatically presented with a predetermined list of completions, such as

Beep
BulletHeight
...

This list of completions is a stored, predetermined list that is displayed automatically, every time any programmer types “Console.” (e.g., in a software development environment with this particular form of autocompletion enabled). In this case, this autocompletion enables the developer to finish this line of code in a same way this autocompletion would enable any programmer, who is programming any type of software program, to complete the same line of code. The same list of completions is presented in many situations where “Console.” is entered by the programmer (e.g., a list of completions that may be included in a textbox for the particular programming language). Although some semantic analysis of the typed-in word may be performed by an autocompletion utility, little or no consideration is given to the programming intent of the programmer.

As such, in general, conventional autocompletion techniques merely complete partially entered program code. Semantic analysis tells us whether or not a computer program makes sense in relation to the objects, properties, and methods available in the particular programming language. However, conventional code compilers cannot infer programmer intent, and thus cannot aid programmers in solving programming problems or otherwise further streamline computer programming.

In contrast, embodiments disclosed herein enable developer intent to be inferred, and enable code solutions to be selected to solve problems associated with the developer's intent. Embodiments therefore enable program code solutions to be provided to developers to solve problems, not just finish a line of code. Such problems may be “how do I” issues, may be problems unbeknownst to the developer prior to writing the code, such as behavioral or capability differences between various platforms, or may be other types of problems.

In an embodiment, developer intent is inferred by analyzing pools of program code generated by pools of developers (e.g., program code generated by tens, hundreds, thousands, and even greater numbers of developers), and understanding which program code design patterns map to what programmer intent. The program code may include source code (a collection of computer program instructions that is written by a code developer in a human-readable programming language), code libraries (including a compiled library that includes instructions that can be parsed and analyzed), etc. Code patterns are identified in the program code generated by the developers, and stored in a knowledge base repository. Each stored code pattern has a pattern signature (code present in program code that identifies the presence of the code pattern), and a code solution. When a pattern signature of a code pattern is identified in program code being generated by a developer, the corresponding code solution may be provided to the developer as a solution suggestion. The developer may select the code solution to be inserted into the program code.

As such, large program code bases may be used to “crowd source” one or more lines of program code to be included in a software program. This may provide many benefits. For instance, the ability to search and reason over all of the source code persisted at an entity (e.g., Merrill Lynch® or other entity) is enabled. The results of that searching/reasoning may be provided to a developer as they write code to assist their code writing.

For example, functions “X” and “Y” may be internal APIs to an entity, and “Z” may be another function. The entity's code base may be analyzed to determine that 98% of the time that a developer calls a function “X”, the developer also calls functions “W” and “Y”, pre- and post-calling function “X”. Similarly, the entity's code base may be analyzed to determine that when a developer calls function “X” in the Microsoft® .NET™ framework, 75% of programs call function “Y” in the Microsoft®.NET™ framework immediately after calling function “X”.

In embodiments, any source code base may be searched and reasoned over, including source code of an entity (e.g., a business, a university or other educational institution, a government agency, etc.) or multiple entities, public and/or private, including source code present anywhere on the Internet. A software development environment may be enabled to reason over the structure of a method, file, or project, and provide suggestions not simply at the character position, but for the method as a whole.

For instance, a method may follow a well-known pattern, established in a book Q, and practiced by 72% of the source code of an entity. In an embodiment, a software development environment could offer a list of design patterns based on the pattern. When a developer selects a pattern, the suggested code of the pattern is inserted into the source code. The inserted code may be modified/corrected to utilize local variables, naming patterns, etc.

In another example, a developer may select a block of code and the development environment may present a “fill” affordance on the code that could be selected and dragged down into the selected code. The development environment may query the source code base (e.g., the “cloud”), find the appropriate pattern, and rewrite existing code and “fill in” the remainder of the pattern, such that the developer effectively drags the new code into view.

In still another example, in an embodiment, the software development environment may identify the differences between target runtime platforms, such that developers may identify and manage features across those platforms. For example, the software development environment may be aware of the API (application programming interface) of Microsoft Windows® Phone versions 7, 8, 9, and 10. When a developer writes to an API defined in version 7 but deprecated in version 9, the alternative API and coding pattern may be presented to the developer in the software development environment. Furthermore, the developer may be prompted with an option to “write platform version resilient code,” which causes code to be inserted that manages the platform difference through “#if def” statements or alternative similar statements. In still another embodiment, the developer may be enabled to repeatedly press a key combination to change the contents presented by the software development environment to cycle through different platform APIs as code options.

In an embodiment, automatic filtering of available code options may be performed based on attributes of the code, what the code requires, and/or requirements of the code (e.g., license information). For example, a developer may be working on code that is annotated as being associated with the Apache License 2.0, a free software license authored by the Apache Software Foundation (ASF). Accordingly, code options from a non-matching license (e.g., code under the GPL v3 license, provided by the Free Software Foundation (F SF) for the GNU (general public license) project) would not be presented to the developer. In this manner, code options are not be presented from non-matching license systems, but if your code base has a matching license to some available code options, then those code options may be presented to be selected and inserted into the developer's code.

As such, in embodiments, reasoning may be performed “in the cloud” (by computing devices in a computer network or combination of computer networks, such as the Internet) based on existing source code bases and documentation. The reasoning (analysis) may infer patterns, next steps, more efficient or robust code, etc., and present this information to the developer in real time in the software development environment. As such, the software development environment moves beyond simple semantic prompting, as in conventional autocorrect techniques, to actually writing program code for the developer though code suggestions, in effect “finishing their sentences”.

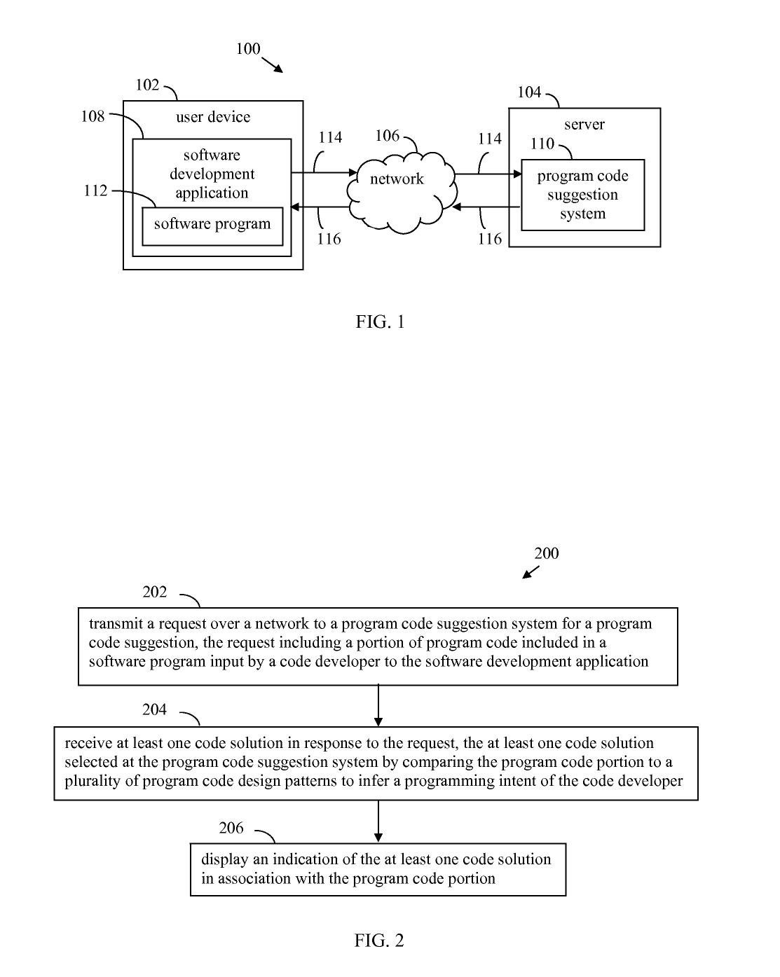

For instance, FIG. 1 shows a block diagram of a software development system 100 that provides program code solutions generated based on an analysis of pools of program code, according to an example embodiment. As shown in FIG. 1, system 100 includes a user device 102 and a server 104, which are communicatively coupled by a network 106. As shown in FIG. 1, user device 102 includes a software development application 108, and server 104 includes a program code suggestion system 110. System 100 is provided as an example embodiment, and embodiments may be implemented in alternative environments. System 100 is described as follows.

Program code suggestion system 110 in server 104 is configured to analyze program code generated by a plurality of developers (e.g., “crowd sourced” program code) to identify code design patterns, and generate pattern signatures and code solutions for the identified code design patterns. Furthermore, program code suggestion system 110 may receive requests for code suggestions for program code being entered into software development application 108. For instance, as shown in FIG. 1, program code suggestion system 110 in server 104 may receive a request 114 from software development application 108 in user device 102 through network 114. A developer may interact with software development application 108 to develop/program a software program 112 in the form of program code. Request 114 may include a program code portion of software program 112, which may be one or more lines of program code, one or more portions of a line of program code, or the entirety of software program 112. Program code suggestion system 110 compares the program code portion to the identified code design patterns to determine one or more matching pattern signatures, and may transmit the corresponding one or more code solutions to software development application 108 as code suggestions. For example, as shown in FIG. 1, software development application 108 in user device 102 may receive code solution(s) 116 from program code suggestion system 110 in server 104. Software development application 108 may present code solution(s) 116 to the developer to enable the developer to select a code solution to be entered into software program 112 if desired.

Server 104 may be any type of computing device capable of serving content, and may include one or more computing devices. User device 102 may be any type of stationary or mobile computing device, including a stationary computer (e.g., a personal computer, a server, etc.) or a mobile computing device such as a handheld device (e.g., a Palm® device, a RIM Blackberry® device, a personal digital assistant (PDA)), a laptop computer, a notebook computer, a tablet computer (e.g., an Apple iPad™, a Microsoft Surface™, etc.), a netbook, a mobile phone (e.g., a smart phone such as an Apple iPhone, a Google Android™ phone, a Microsoft Windows® phone, etc.), or other type of computing device.

Software development application 108 may be any type of commercially available or proprietary software development application, software development environment, or integrated development environment, such as Microsoft® Visual Studio®, developed by Microsoft Corporation of Redmond, Wash., JDeveloper® supplied by Oracle Corporation of Redwood City, Calif., Cloud9 IDE developed by Cloud9 IDE, Inc. of San Francisco, Calif., and ActiveState® Komodo® provided by ActiveState Software Inc. of Vancouver, British Columbia. These examples of software development application 108 are provided merely for purposes of illustration, and are not intended to be limiting, as many further types of applicable software development applications exist, as would be known to persons skilled in the relevant art(s).

Software program 112 may include program code of any type of programming language, including C/C++, VB.NET (Visual Basic .NET), C#, F#, M, Python, Ruby, XML/XSLT, HTML/XHTML, Java, JavaScript, CSS, SQL, BPEL, PHP, Perl, Tcl, etc. These examples of programming languages are provided merely for purposes of illustration, and are not intended to be limiting, as many further types of applicable programming languages exist, as would be known to persons skilled in the relevant art(s).

User device 102 and server 104 are communicatively coupled by network 106. Network 106 may include one or more communication links and/or communication networks, such as a PAN (personal area network), a LAN (local area network), a WAN (wide area network), or a combination of networks, such as the Internet. User device 102 and server 104 may be communicatively coupled to network 106 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

A single user device 102 is shown in FIG. 1 for purposes of illustration. However, any number of user devices 102 may be present in system 100 that communicate with server 104 to receive code solutions, including tens, hundreds, thousands, and even greater numbers of user devices 102.

The elements of software development system 100 shown in FIG. 1 may be configured in various ways, in embodiments. Example embodiments for software development system 100 are described in the following subsections.

### A. Example Embodiments for a Software Development Application that Displays Crowd Sourced Code Solutions

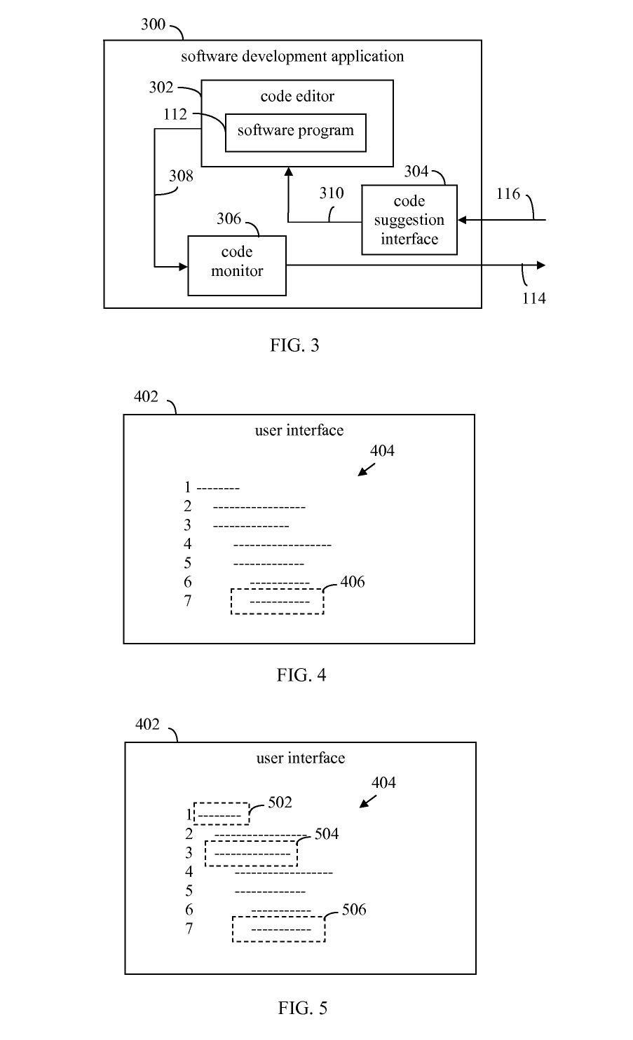

As described above, a software development application, such as software development application 108, may be enabled to display code solutions for developers that are using the software development application to generate program code. Such a software development application may be configured in various ways, and may perform its functions in various ways. For instance, FIG. 2 shows a flowchart 200 providing a process for a software development application that requests and receives a program code solution generated based on an analysis of pools of program code, according to an example embodiment. Software development application 108 of FIG. 1 may operate according to flowchart 200, in an embodiment. For purposes of illustration, flowchart 200 of FIG. 2 is described with respect to FIG. 3. FIG. 3 shows a block diagram of a software development application 300 that provides program code solutions to developers that are generated based on an analysis of pools of program code, according to an example embodiment. Software development application 300 is an example of software development application 108 of FIG. 1. As shown in FIG. 3, software development application 300 includes a code editor 302, a code suggestion interface 304, and a code monitor 306. Flowchart 200 and software development application 300 are described as follows. Further structural and operational embodiments will be apparent to persons skilled in the relevant art(s) based on the following description.

Flowchart 200 begins with step 202. In step 202, a request is transmitted over a network to a program code suggestion system for a program code suggestion, the request including a portion of program code included in a software program input by a code developer to the software development application. As described above, software development application 108 may transmit request 114 to program code suggestion system 110 in server 104 for code solutions for program code being entered into software program 112 by a developer. Request 114 may include a program code portion of software program 112.

Referring to FIG. 3, a developer may interact with code editor 302 of software development application 300 to enter and edit program code when generating software program 112. For instance, the developer may add, modify, or delete program code text using code editor 302 such as by typing, by voice input, etc. When complete, or at other intervals, the user may be enabled to save the program code by interacting with a “save” button or other user interface element. Code editor 302 may be a browser based editor, a code editor integrated in a desktop or mobile application, or any other type of code editor.

Code monitor 306 may monitor input of program code to software program 112 by the developer at code editor 302, as indicated by a program code portion 308 received by code monitor 306. Code monitor 302 may receive any portion of software program 112 in program code portion 308, including receiving each character input to code editor 302, character-by-character, receiving each complete term (e.g., set of alphanumeric characters) as the term is input to code editor 302 (e.g., as separated by periods, space characters, or other separators), receiving each complete line of code input as it is input to code editor 302, or receiving software program 112 in its entirety. In an embodiment, code monitor 306 may generate request 114, and may include program code portion 308 in request 114. Request 114 may transmitted to program code suggestion system 110 at server 104 using a network interface included in or accessible to code monitor 302. In embodiments, code monitor 302 may be configured to identify the presence of particular program code or combinations of program code, to be provided in program code portion 308, or may be configured to forward program code portion 308 without analysis.

For instance, FIGS. 4 and 5 show block diagrams of a user interface 402 that displays program code entered by a developer that is analyzed for code solutions, according to an example embodiment (program code is represented as dashes for purposes of illustration). User interface 402 is a user interface (e.g., graphical user interface (GUI), text editor interface, etc.) generated by code editor 302 to enable program code to be entered and edited by a developer, such as program code 404 shown in FIGS. 4 and 5. Program code 404 may be a portion of software program 112 shown in FIG. 1. In the examples of FIGS. 4 and 5, program code 404 includes seven lines of code. As described above, code monitor 306 of FIG. 3 may monitor program code 404 for forwarding in request 114. Referring to FIG. 4, code monitor 306 may receive a most recent line of code 406 as program code portion 308, and may forward line of code 406 to program code suggestion system 110 at server 104 in request 114. In the example of FIG. 5, code monitor 306 may identify a particular combination of code in program code 404, such as including first, third, and seventh lines of code 502, 504, and 506, and may forward the combination of code to program code suggestion system 110 at server 104 in request 114. In further examples, code monitor 306 may identify and forward any other portions of code in program code 404, including the entirety of program code 404.

Referring back to FIG. 2, in step 204, at least one code solution is received in response to the request, the at least one code solution selected at the program code suggestion system by comparing the program code portion to a plurality of program code design patterns to infer a programming intent of the code developer. As described above, software development application 108 of FIG. 1 may receive code solution(s) 116 from program code suggestion system 110 in server 104. Code solution(s) 116 includes one or more code solutions selected at program code suggestion system 110 by comparing the program code portion provided in request 114 to a plurality of program code design patterns. The program code design patterns may be generated at program code suggestion system 110 by analyzing a pool of program code (a program code base) that includes program code provided from any number of developers. The analysis of the pool of program code may identify programming patterns of the developers, such as identifying a first code term, function, method, and/or other section of program code (a pattern signature) that, if input by a developer, there is a likelihood that the developer will input a second code term, function, method and/or other section of program code (a code solution). In this manner, the analysis infers a programming intent of the code developer by anticipating program code that the code developer is likely to enter following the program code portion provided in request 114.

For instance, as shown in FIG. 3, code suggestion interface 304 may receive code solution(s) 116 through a network interface included in or accessible to code suggestion interface 304.

In step 206, an indication is displayed of the at least one code solution in association with the program code portion. As described above, software development application 108 of FIG. 1 may present code solution(s) 116 to the developer to enable the developer to select a code solution to be entered into software program 112 if desired. Referring to FIG. 3, code suggestion interface 304 may be configured to provide code solution(s) 116 to code editor 302 for display as selectable solution(s) 310. Selectable solution(s) 310 is/are displayed in association with the program code portion included in request 114. In this manner, a developer can view and select one of selectable solution(s) 310, if desired, to be entered into software program.

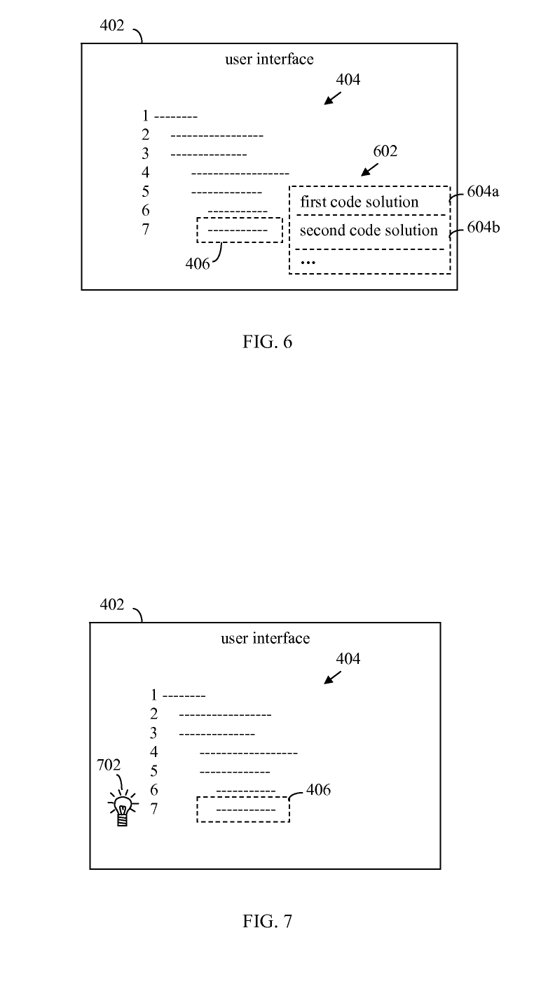

For instance, FIG. 6 shows a block diagram of user interface 402 displaying selectable code solutions 602, according to an example embodiment. Selectable code solutions 602 are displayed as code solutions for line of code 406, as determined by program code suggestion system 110 (FIG. 1) and provided in code solution(s) 116. As shown in FIG. 6, selectable code solutions 602 includes a first code solution 604a, a second code solution 604b, and potentially further code solutions. Each code solution of selectable code solutions 602 is enabled to be selected by the developer (e.g., using a mouse click, a key combination, a gesture applied to a touch screen or other gesture interface, voice, etc.) to be inserted into program code 404.

Each displayed code solution may include any number of lines of code. Furthermore, although code solutions 602 are shown displayed to the right of line of code 406 in FIG. 6, code solutions 602 may be displayed in any other location of user interface 402, including above line of code 406, below line of code 406, on top of line of code 406 (e.g., as transparent or non-transparent), or to the left of line of code 406. Code solutions 602 may be displayed in list form (when more than one code solution is present) or in other forms. Furthermore, code solutions 602 may be automatically displayed to the developer when received, or may not be automatically displayed. Code solutions 602 may include one or more of different code solutions, code solutions that are the same but correspond to different software and/or device hardware versions, etc. For instance, in an embodiment, the developer may be enabled to use a key combination (or other user interface interaction) to change the contents of code solutions 602 to cycle through different platform APIs and/or other code solution variations, to be enabled to select “write platform version resilient code” (which inserts program code that manages platform differences through #if def (or similar) statements), etc.).

For example, FIG. 7 shows a block diagram of user interface 402, according to another example embodiment. In the example of FIG. 7, a user interface control 702 is displayed in user interface 402 that identifies that one or more code solutions have been received (for line of code 406 in this example). User interface control 702 may be interacted with by the developer to cause the received code solution(s) to be displayed (e.g., as described above with respect to FIG. 6). In this manner, code solutions are not automatically displayed to the developer, which may be disruptive to the developer's work, but instead, an indication of the presence of code solutions is provided so that the developer has the option of displaying the code solutions if desired.

In the example of FIG. 7, user interface control 702 is displayed as an icon (e.g., a light bulb), but in other embodiments may be displayed in other ways, such as in the form of a pull down menu, radio button, check boxes, etc. Although user interface control 702 is shown displayed to the left of line of code 406 in FIG. 7, user interface control 702 may be displayed in any other location of user interface 402, including above line of code 406, below line of code 406, on top of line of code 406 (e.g., as transparent or non-transparent), or to the left of line of code 406.

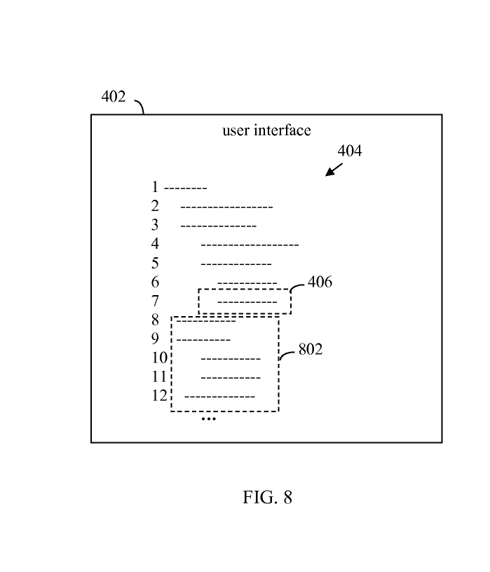

The selected code solution may be automatically or manually inserted into program code in any manner, including being inserted at one location, or having portions inserted at multiple locations, depending on the particular code solution. FIG. 8 shows a block diagram of user interface 402 displaying a selected code solution 802 inserted into program code 404, according to an example embodiment. In the example of FIG. 8, selected code solution 802 is inserted beginning at a next line after the line of code 406 (e.g., lines 8-12). In other embodiments, selected code solution 802 may be inserted into program code 404 at other locations, including being inserted before line of code 406, having portions inserted both above and below line of code 406, or being inserted at other location or combinations of locations. In an embodiment, selected code solution 802 may partially or entirely overwrite line of code 406 and/or other portion of program code 404.

In another embodiment, knowledge of the programming language in which program code 404 is being written may be maintained, and thus knowledge of things such as the syntax tree of program code 406 may be known. This may enable code solutions to be applied that are not merely inserted in program code 404, but that apply structurally to program code 404, such as by modifying the structure of program code 404 (e.g., adding an attribute to a class or method containing line of code 406, adding new fields/methods/other members to a current class, refactoring a current class into a set of related classes, etc.), by automatically adding a library reference from a current coding project to import desired functionality, by plugging in information based on deep compiler-based knowledge of the code structure and not just source file lines, etc.

Furthermore, in an embodiment, selected code solution 802 received from the server may have one or more attributes, variables, parameters, or other fields that are incomplete. Such fields may be fillable with information that is specific to the particular program code into which selected code solution 802 is being inserted. In an embodiment, code suggestion interface 304 may modify selected code solution 802 by filling at least one fillable field of the selected code solution, and may insert the modified code solution into program code 404. Code suggestion interface 304 may detect the information to be filled into selected code solution 802 (e.g., by finding indications of the field values elsewhere in program code 404, by detecting tags, etc.), and may automatically fill in the fields with the detected information. In another embodiment, code suggestion interface 304 may detect and display the information to be filled in, and may enable the developer to cause the information to fill in the fields (e.g., by drag-and-dropping the information, clicking on the information, editing the information, etc.). In still another embodiment, code suggestion interface 304 may request that the developer manually fill in the fields by displaying selected code solution 802, indicating the field(s) needing to be filled in, and enabling the user to input the information.

In this manner, a developer is assisted in generating program code by having code solutions presented that are determined based on the work of other developers (and in some cases, past work of the developer himself/herself), and that therefore have a reasonable likelihood of relating to an actual programming intent of the developer. The following subsections describe example embodiments for analyzing the work of developers for design patterns that may be used to identify code solutions, as well as example embodiments for providing such code solutions to developers in real time.

### B. Example Embodiments for a Program Code Suggestion System that Compiles and Provides Crowd Sourced Code Solutions

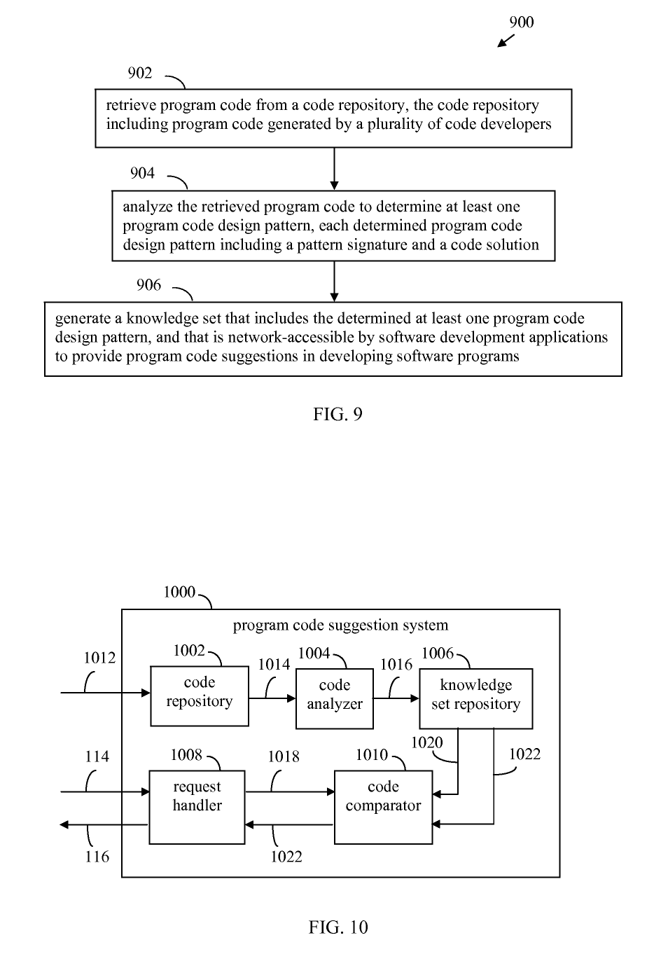

As described above, a program code suggestion system, such as program code suggestion system 110 of FIG. 1, may be enabled to provide code solutions for developers that are using software development applications to generate program code. Such a program code suggestion system may be configured in various ways, and may perform its functions in various ways. For instance, FIG. 9 shows a flowchart 900 providing a process for crowd source generating a repository of program code design patterns, according to an example embodiment, according to an example embodiment. Program code suggestion system 110 of FIG. 1 may operate according to flowchart 900 to determine program code design patterns that may be used to assist developers, in an embodiment. For purposes of illustration, flowchart 900 of FIG. 9 is described with respect to FIG. 10. FIG. 10 shows a block diagram of a program code suggestion system 1000 that generates crowd sourced program code solutions, and provides the generated suggestions to software development applications, according to an example embodiment. Program code suggestion system 1000 is an example of program code suggestion system 110 of FIG. 1. As shown in FIG. 10, program code suggestion system 1000 includes a code repository 1002, a code analyzer 1004, a knowledge set repository 1006, a request handler 1008, and a code comparator 1010. Flowchart 900 and program code suggestion system 1000 are described as follows. Further structural and operational embodiments will be apparent to persons skilled in the relevant art(s) based on the following description.

Flowchart 900 begins with step 902. In step 902, program code is retrieved from a code repository, the code repository including program code generated by a plurality of code developers. For example, as shown in FIG. 10, code repository 1002 receives and stores collected program code 1012. Collected program code 1012 is program source code, which may be in the form of tens, hundreds, thousands, millions, and even greater numbers of software programs, program files, blocks of code, methods, etc., generated by a plurality of developers. Collected program code 1012 may be collected from any number of sources (e.g., computing devices, storage devices, etc.), and may include program code of any number of entities (e.g., individual programmers, businesses, universities or other educational institutions, government agencies, etc.). Code repository 1002 may have any structure, and may include any type and amount of storage to collect and store collected program code 1012. For instance, code repository 1002 may be a location (e.g., a web site or service, an API, etc.) where developers may manually store source code. In another embodiment, code repository 1002 may include a web crawler that crawls one or more network locations to retrieve source code in an automated manner. In still another embodiment, code repository 1002 may include a combination of manual and automated techniques for collecting source code.

Code repository 1002 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium to store collected program code 1012.

As shown in FIG. 10, code analyzer 1004 may retrieve program code 1014 from code repository 1002. Program code 1014 may include a portion of the source code included in code repository 1002 (e.g., a portion received since a previous portion was retrieved), or the entirety of the source code included in code repository 1002.

In step 904, the retrieved program code is analyzed to determine at least one program code design pattern, each determined program code design pattern including a pattern signature and a code solution. In an embodiment, code analyzer 1004 is configured to analyze program code 1014 retrieved from code repository 1002 to determine one or more program code design patterns that each include a pattern signature and a code solution. A program code design pattern indicates that when a developer inputs particular first program code (the pattern signature), the developer frequently inputs particular second program code (the code solution). For instance, the developer may input the code solution following the pattern signature more than 50% of the time or other predetermined percentage of the time to be considered a design pattern. As such, code analyzer 1004 is configured to analyze program code 1014 to determine such design patterns.

For instance, code analyzer 1004 may parse program code 1014 to locate a particular first code function (function X) occurring multiple times in a portion of program code 1014 (e.g., in a same program code file, in multiple different program code files, etc.). Furthermore, when further parsing program code 1014, code analyzer 1004 may determine that a second code function (function Y) also occurs in the same portion of program code 1014. As such, code analyzer 1004 may correlate the first and second code functions into a generated program code design pattern (e.g., design pattern Z) as the pattern signature and the code solution. Code analyzer 1004 may repeat this any number of times to generate any number of design patterns. As shown in FIG. 10, code analyzer generates program code design patterns 1016, which includes the determined design patterns.

Code analyzer 1004 may use any commercially available or proprietary techniques described herein or otherwise known for recognizing design patterns in program code. For instance, code analyzer 1004 may use one or more techniques of supervised or unsupervised learning, clustering, neural networks, machine learning, etc. to determine pattern signatures and corresponding code solutions.

In step 906, a knowledge set is generated that includes the determined at least one program code design pattern, and that is network-accessible by software development applications to provide program code suggestions in developing software programs. For example, as shown in FIG. 10, program code design patterns 1016 are received by knowledge set repository 1006. Knowledge set repository 1006 stores program code design patterns 1016 in a knowledge set, and may organize program code design patterns 1016 for retrieval in any manner.

Knowledge set repository 1006 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium to store program code design patterns 1016.

Thus, program code suggestion system 1000 may analyze a source code base to generate a repository of program code design patterns. In embodiments, software development applications, such as software development application 108 of FIG. 1, may be enabled to request code solutions of program code design patterns 1016 based on program code that developers input to the software development applications. In this manner, the programming intent of the developers may be inferred based on a collected history of programming solutions in the source code based generated by developers—e.g., crowd sourcing of programming solutions.

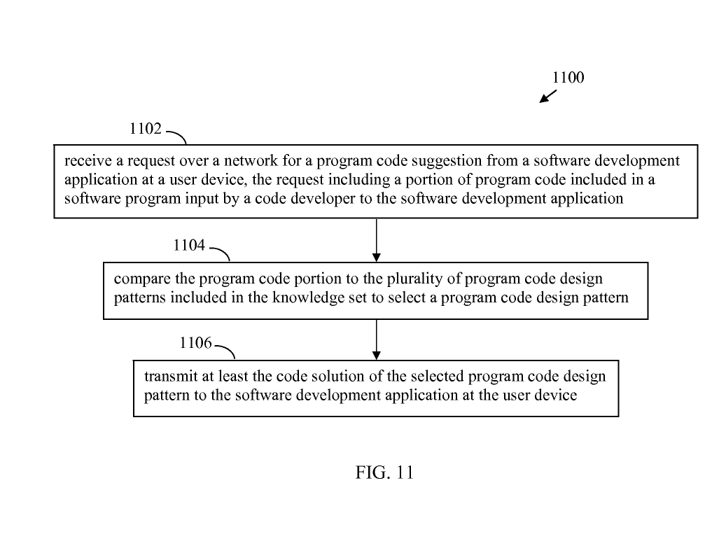

Program code suggestion system 1000 may provide the code solutions to requesting software development applications in various ways. For instance, FIG. 11 shows a flowchart 1100 providing a process for providing crowd sourced program code solutions to software development applications in response to requests, according to an example embodiment. Program code suggestion system 1000 of FIG. 10 may operate according to flowchart 1100, in an embodiment. For purposes of illustration, flowchart 1100 is described with respect to FIG. 10 as follows. Further structural and operational embodiments will be apparent to persons skilled in the relevant art(s) based on the following description.

Flowchart 1100 begins with step 1102. In step 1102, a request is received over a network for a program code suggestion from a software development application at a user device, the request including a portion of program code included in a software program input by a code developer to the software development application. For instance, as described above with respect to FIG. 1, software development application 108 (e.g., code monitor 302 of FIG. 3) may transmit request 114, which is a request for code solutions associated with program code entered by a developer to software development application 108, such as software program 112. Request 114 may include a program code portion of software program 112. As shown in FIG. 3, request handler 1008 may receive request 114. Request handler 1008 may receive request 114 through a network interface included in or accessible to request handler 1008.

In step 1104, the program code portion is compared to the plurality of program code design patterns included in the knowledge set to select a program code design pattern. As shown in FIG. 10, code comparator 1010 may receive a program code portion 1018 included in request 114. Program code portion 1018 is a portion of the program code entered by the developer into software program 112 of FIG. 1 (e.g., program code portion 308 of FIG. 3). In an embodiment, code comparator 1010 is configured to compare program code portion 1018 to the design patterns included in knowledge set repository 1006. For instance, as shown in FIG. 10, code comparator 1010 may receive pattern signatures 1020 from knowledge set repository 1006. Pattern signatures 1020 may include one or more of the patterns signatures of the design patterns stored in knowledge set repository 1006. Code comparator 1010 may be configured to compare program code portion 1018 to pattern signatures 1020 to determine whether there are any matches. For instance, a function X included in program code portion 1018 may be compared to pattern signatures 1020 to determine whether function X is a pattern signature included therein. If one or more matches is found (e.g., an exact match, a match of over a predetermined percentage of code, etc.), code comparator 1010 retrieves the code solution(s) from knowledge set repository 1006 corresponding to the one or more matching pattern signatures in code solution(s) 1022.

Code comparator 1010 may perform various forms of analysis when comparing program code portion 1018 to pattern signatures 1020 to determine whether there are any matches. For instance, in embodiments, code comparator 1010 may perform a string comparison (e.g., comparing code letter by letter, etc.), may analyze the text, analyze the language syntax tree, may analyze the resulting binary form, may analyze the architectural layering, may analyze information provided by the compiler about semantic meaning, may analyze tracked information as the developer was writing the code to see the form/order/style/timing in which the developer wrote the code to extract corresponding meaning, etc.

Note that in embodiments, code comparator 1010 may perform further comparisons before providing code solutions. For instance, in an embodiment, for code solutions corresponding to matching pattern signatures, code comparator 1010 may determine whether the code solutions are compatible with a software version at the user device of the developer (e.g., user device 102), or are otherwise compatible with hardware and/or software of the user device. In some cases, code comparator 1010 may select a code solution that is compatible with a hardware and/or software version at the user device (e.g., compatible with an API defined in Windows Phone version 7, etc.). In some embodiments, code comparator 1010 may select multiple versions of a code solution, and the developer may be enabled to select one of the versions of the code solution. In another embodiment, code comparator 1010 may select a code solution that is platform version resilient code.

Thus, in an embodiment, code comparator 1010 may select code solutions that are compatible with the program code being written by the developer (e.g., are a compatible version, are compatible with present hardware, etc.). Furthermore, in an embodiment, code comparator 1010 may select code solutions that are trusted by the developer and/or are compatible with rights associated the developer's program code. For instance, the developer may want to avoid code solutions associated with open source licenses being inserted into proprietary program code being developed by the developer. As such, program code suggestion system 1000 may maintain metadata on the provenance of a particular code solution, and use that metadata in combination with information provided by the developer requesting code solutions, to determine whether a code solution is appropriate for recommendation.

In step 1106, at least the code solution of the selected program code design pattern is transmitted to the software development application at the user device. For example, as shown in FIG. 10, request handler 1008 receives code solution(s) 1022 from code comparator 1010. Request handler 1008 transmits code solution(s) 1022 to software development application 108 in code solution(s) 116. Request handler 1008 may transmit code solution(s) 116 through a network interface included in or accessible to request handler 1008.

Accordingly, as described above, software development application 108 may display code solution(s) 116 to the developer, and the developer may be enabled to select a code solution to be inserted into the software program under development by the developer.

### C. Further Example Embodiments

As described above, a software development application may communicate over a network to received program code solutions from a program code suggestion system. In another embodiment, the software development application and the program code suggestion system may be located in a same computing device. For instance, referring to FIG. 1, both software development application 108 and program code suggestion system 110 may be located in user device 102. In this manner, software development application 108 may communicate directly with program code suggestion system 110 in user device 102 to receive program code solutions. As such, embodiments described above (e.g., as shown in FIGS. 1, 2, 9, and 11) may be modified so that request 114 is a communication made internal to user device 102, and code solution(s) 116 is received from software development application 108 in user device 102, rather than making communications through network 106.

In another embodiment similar to FIG. 1, a software development application may communicate over a network to received program code solutions from a program code suggestion system. Furthermore, a catalog of code solutions may be cached local to the software development application so that the software development application can receive code solutions from the cache even while operating offline (e.g., during a network outage, etc.). For instance, referring to FIG. 1, program code suggestion system 110 may transmit a catalog of code solutions through network 106 to software development application 108 to be stored at user device 102 in memory (e.g., cache) or other storage. The catalog of code solutions may be accessed at user device 102 by software development application 108 to receive code solutions even when unable to communicate through network 106.

In another embodiment, code solutions may be provide in a batch mode, where the developer may be enabled to interact with a user interface of the software development application to request that software program be analyzed in its entirety. As such, when such a batch mode analysis request is made by the developer, the software development application may provide the software program to the program code suggestion system (or may access the cached code solutions), and the program code suggestion system may analyze the software program and provide code solutions as described herein. Based on the analysis of the software program (e.g., structures, patterns, etc.) the software development application may display code solution recommendations for replacing pieces of code of the software program. For example, the program code suggestion system may recognize that the developer has written a lazy initializer (a possible pattern where some data is initialized on-demand when it is first accessed rather than earlier), but that the developer has not written the lazy initializer in a thread-safe manner. As such, the program code suggestion system may retrieve code solutions from its knowledge base code solutions that provide thread-safe lazy initialization alternatives.

Furthermore, when a proposed code solution is selected to be inserted into program code, the program code suggestion system may receive and store an indication of which code solution was selected (e.g., in knowledge set repository 1006 of FIG. 10), thereby tracking selected code solutions and the program code context in which they are selected. This correlated information (the selected code solution and the program code into which the selected code solution is inserted) may be fed back to code analyzer 1004 to bolster the knowledge stored in knowledge set repository 1006 so as to influence subsequent recommendations.

### III. Example Computing Device Embodiments

Software development application 108, program code suggestion system 110, code editor 302, software development application 300, code suggestion interface 304, code monitor 306, program code suggestion system 1000, code analyzer 1004, request handler 1008, code comparator 1010, flowchart 200, flowchart 900, and flowchart 1100 may be implemented in hardware, or hardware with any combination of software and/or firmware. For example, software development application 108, program code suggestion system 110, code editor 302, software development application 300, code suggestion interface 304, code monitor 306, program code suggestion system 1000, code analyzer 1004, request handler 1008, code comparator 1010, flowchart 200, flowchart 900, and/or flowchart 1100 may be implemented as computer program code configured to be executed in one or more processors and stored in a computer readable storage medium. Alternatively, software development application 108, program code suggestion system 110, code editor 302, software development application 300, code suggestion interface 304, code monitor 306, program code suggestion system 1000, code analyzer 1004, request handler 1008, code comparator 1010, flowchart 200, flowchart 900, and/or flowchart 1100 may be implemented as hardware logic/electrical circuitry.

For instance, in an embodiment, one or more of software development application 108, program code suggestion system 110, code editor 302, software development application 300, code suggestion interface 304, code monitor 306, program code suggestion system 1000, code analyzer 1004, request handler 1008, code comparator 1010, flowchart 200, flowchart 900, and/or flowchart 1100 may be implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

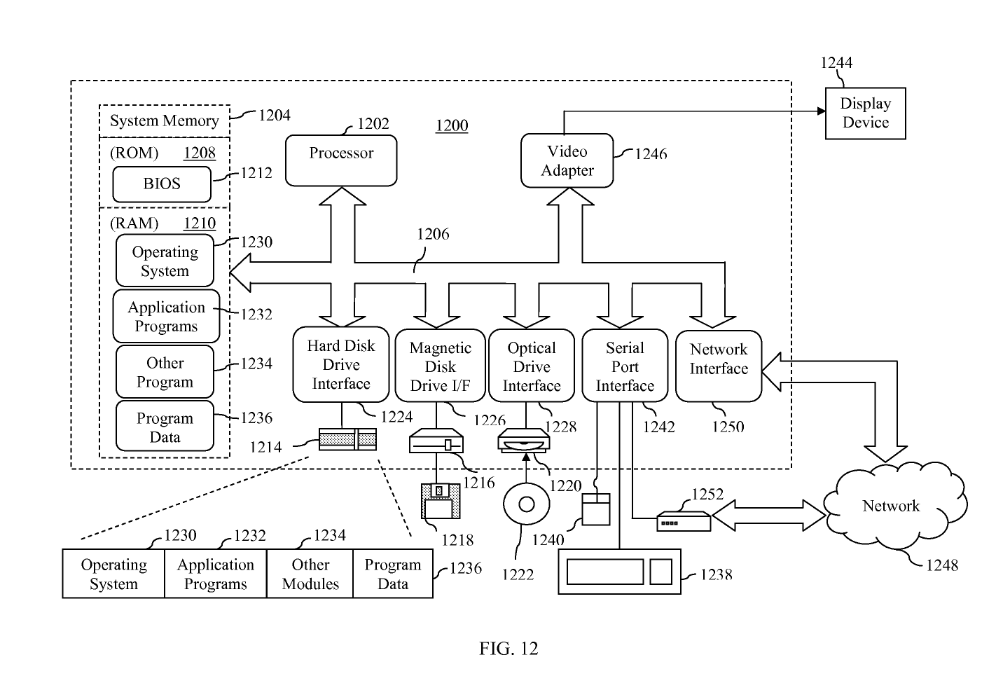

FIG. 12 depicts an exemplary implementation of a computer 1200 in which embodiments of the present invention may be implemented. For example, user device 102 and/or server 104 may be implemented in one or more computer systems similar to computer 1200, including one or more features of computer 1200 and/or alternative features. The description of computer 1200 provided herein is provided for purposes of illustration, and is not intended to be limiting. Embodiments of the present invention may be implemented in further types of computer systems, as would be known to persons skilled in the relevant art(s).

As shown in FIG. 12, computer 1200 includes one or more processors 1202, a system memory 1204, and a bus 1206 that couples various system components including system memory 1204 to processor 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic (e.g., computer program code or instructions) for implementing software development application 108, program code suggestion system 110, code editor 302, software development application 300, code suggestion interface 304, code monitor 306, program code suggestion system 1000, code analyzer 1004, request handler 1008, code comparator 1010, flowchart 200, flowchart 900, and/or flowchart 1100 (including any step of flowcharts 200, 900, and 1100), and/or further embodiments described herein.

A user may enter commands and information into the computer 1200 through input devices such as keyboard 1238 and pointing device 1240. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 1202 through a serial port interface 1242 that is coupled to bus 1206, but may be connected by other interfaces, such as a parallel port, game port, or a universal serial bus (USB).

A display component 1244 is also connected to bus 1206 via an interface, such as a video adapter 1246. In addition to the monitor, computer 1200 may include other peripheral output devices (not shown) such as speakers and printers.

Computer 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium” are used to generally refer to media such as the hard disk associated with hard disk drive 1214, removable magnetic disk 1218, removable optical disk 1222, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250, serial port interface 1242, or any other interface type. Such computer programs, when executed or loaded by an application, enable computer 1200 to implement features of embodiments of the present invention discussed herein. Accordingly, such computer programs represent controllers of the computer 1200.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
retrieving program code from a code repository, the code repository including program code generated by one or more code developers associated with at least one entity;
analyzing the retrieved program code to determine at least one program code design pattern, each determined program code design pattern including a pattern signature and a code solution; and
generating a knowledge set that includes the determined at least one program code design pattern, and that is accessible by software development applications to provide program code suggestions in developing software programs.

2. The method of claim 1, further comprising:
receiving a request for a program code suggestion from a software development application at a user device, the request including a portion of program code included in a software program input by a code developer to the software development application;
comparing the program code portion to the plurality of program code design patterns included in the knowledge set to select a program code design pattern; and
transmitting the code solution of the selected program code design pattern to the software development application at the user device.

3. The method of claim 2, wherein said comparing comprises:
inferring a programming intent of the code developer to select the program code design pattern from the plurality of program code design patterns included in the knowledge set.

4. The method of claim 2, wherein said comparing comprises:
selecting the program code design pattern to have a code solution that is compatible with a software version at the user device, that is platform version resilient code, or that is license compatible with the software program.

5. The method of claim 2, wherein said comparing comprises:
selecting the program code design pattern having a code solution to be inserted in the software program before the program code portion or beginning at a next line after the program code portion.

6. The method of claim 2, wherein said comparing comprises:
modifying a structure of the software program.

7. The method of claim 2, wherein the code solution of the selected program code design pattern includes at least one fillable field to be filled in at the software development application.

8. A program code suggestion system, comprising:
a code analyzer configured to receive program code generated by one or more code developers associated with at least one entity, and to analyze the received program code to determine at least one program code design pattern, each determined program code design pattern including a pattern signature and a code solution; and
a knowledge set repository that includes the determined at least one program code design pattern, and that is accessible by software development applications to provide program code suggestions in developing software programs.

9. The program code suggestion system of claim 8, further comprising:
a code repository that stores the program code generated by the one or more code developers associated with the at least one entity.

10. The program code suggestion system of claim 8, further comprising:
a request handler configured to receive a request for a program code suggestion from a software development application at a user device, the request including a portion of program code included in a software program input by a code developer to the software development application; and
a code comparator that compares the program code portion to the plurality of program code design patterns included in the knowledge set to select a program code design pattern, and
the request handler transmits at least the code solution of the selected program code design pattern to the software development application at the user device.

11. The program code suggestion system of claim 9, wherein the code comparator infers a programming intent of the code developer by understanding which program code design patterns map to what programmer intent to select the program code design pattern from the plurality of program code design patterns included in the knowledge set.

12. The program code suggestion system of claim 9, wherein the code comparator selects the program code design pattern to have a code solution that is compatible with a software version at the user device, is platform version resilient code, or is license compatible with the software program.

13. The program code suggestion system of claim 9, wherein the code comparator selects the program code design pattern having a code solution to be inserted in the software program before the program code portion, or beginning at a next line after the program code portion.

14. The program code suggestion system of claim 9, wherein the code solution of the selected program code design pattern includes at least one fillable field to be filled in at the software development application.

15. A software development application in a user device, comprising:
a code monitor configured to transmit a request over a network to a program code suggestion system for a program code suggestion, the request including a portion of program code included in a software program input by a code developer to the software development application; and
a code suggestion interface configured to receive at least one code solution in response to the request, the at least one code solution selected at the program code suggestion system by comparing the program code portion to a plurality of program code design patterns to infer a programming intent of the code developer; and
the code suggestion interface is configured to enable display of an indication of the at least one code solution in association with the program code portion.

16. The program code suggestion system of claim 15, wherein code suggestion interface displays a user interface control that enables the code developer to display the at least one code solution.

17. The program code suggestion system of claim 15, wherein based on the received at least one code solution, the code suggestion interface displays a plurality of code solutions and enables the code developer to select a code solution of the plurality of code solutions to be inserted into the software program.

18. The program code suggestion system of claim 17, wherein the code suggestion interface automatically inserts the selected code solution in the software program before the program code portion or beginning at a next line after the program code portion.

19. The program code suggestion system of claim 17, wherein the code suggestion interface automatically modifies the selected code solution by filling at least one fillable field of the selected code solution, and inserts the modified code solution into the software program.

20. The program code suggestion system of claim 15, wherein the code suggestion interface displays a code solution for selection that is compatible with a software version at the user device, is platform version resilient code, or is license compatible with the software program.
